(19) United States
(12) Patent Application Publication
(10) Pub. No.: US 2016/0205656 A1
(43) Pub. Date: Jul. 14, 2016

(54) DETERMINATION OF OBJECT-TO-OBJECT POSITION USING DATA FUSION TECHNIQUES

(71) Applicant: GM GLOBAL TECHNOLOGY OPERATIONS LLC, Detroit, MI (US)

(72) Inventors: SHUQING ZENG, STERLING HEIGHTS, MI (US); FAN BAI, ANN ARBOR, MI (US); UPALI PRIYANTHA MUDALIGE, OAKLAND TOWNSHIP, MI (US)

(21) Appl. No.: 14/595,612

(22) Filed: Jan. 13, 2015

(51) Int. Cl. H04W 64/00; H04L 29/08; H04W 4/00; G01S 19/13; H04W 4/02

(52) U.S. Cl. CPC H04W 64/003; G01S 19/13; H04W 4/02; H04W 4/005; H04L 67/12

(57) ABSTRACT

Techniques and methodologies for determining a relative position between a host object and a neighboring object in proximity to the host object are presented here. An exemplary embodiment of a method operates a first wireless communication module onboard the host object to wirelessly communicate packets with a second wireless communication module onboard the neighboring object. The method processes packets wirelessly received from the second wireless communication module to obtain position information related to a position of the neighboring object relative to the host object. A range sensor system onboard the host object is operated to obtain first range information related to a range of the neighboring object relative to the host object. The relative position between the host object and the neighboring object is computed using the obtained position information and the obtained first range information.

### TECHNICAL FIELD

Embodiments of the subject matter described herein relate generally to a system and related operating methods for determining the relative position of neighboring objects relative to a host object.

### BACKGROUND

Although GPS-based methodologies can be very effective, their performance can be compromised under some circumstances. For example, if clouds, trees, buildings, or other structures interfere with GPS reception at the vehicles, then the GPS data may be inaccurate. Indeed, GPS-based methodologies may suffer whenever GPS reception is weak or unavailable. Accordingly, it is desirable to have a system and related methodology for determining relative vehicle positioning, that does not exclusively or predominantly depend on GPS availability for accuracy. Furthermore, other desirable features and characteristics will become apparent from the subsequent detailed description and the appended claims, taken in conjunction with the accompanying drawings and the foregoing technical field and background.

### BRIEF SUMMARY

Presented here is an exemplary embodiment of a method for determining a relative position between a host object and a neighboring object in proximity to the host object. The method operates a first wireless communication module onboard the host object to wirelessly communicate packets with a second wireless communication module onboard the neighboring object. The method continues by processing packets wirelessly received from the second wireless communication module to obtain position information related to a position of the neighboring object relative to the host object. A range sensor system onboard the host object is operated to obtain first range information related to a range of the neighboring object relative to the host object, and the relative position between the host object and the neighboring object is computed using the obtained position information and the obtained first range information.

Also presented is an exemplary embodiment of a system for determining a relative position between a host object and a neighboring object in proximity to the host object. The system includes: a first wireless communication module onboard the host object, and configured to wirelessly communicate data packets with a second wireless communication module onboard the neighboring object; a range sensor system onboard the host object, and configured to obtain first range information related to a range of the neighboring object relative to the host object; and a processor device. The processor device cooperates with the system to process data packets wirelessly received from the second wireless communication module to obtain position information related to a position of the neighboring object relative to the host object, and to compute the relative position between the host object and the neighboring object using the obtained position information and the obtained first range information.

Also presented is a tangible and non-transitory computer readable storage medium having executable instructions stored thereon that, when executed by a processor device, are capable of performing a method that involves: wirelessly communicating data packets between a first wireless communication module onboard the host object and a second wireless communication module onboard the neighboring object; processing data packets wirelessly received from the second wireless communication module to obtain position information related to a position of the neighboring object relative to the host object; operating a range sensor system onboard the host object to obtain first range information related to a range of the neighboring object relative to the host object; and computing the relative position between the host object and the neighboring object using the obtained position information and the obtained first range information.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates system components onboard a host object (such as a vehicle) and a neighboring object (such as another vehicle near the host vehicle);

FIG. 2 is a top view diagram that illustrates a host vehicle and three neighboring vehicles approaching a road intersection; and

FIG. 3 is a flow chart that illustrates an exemplary embodiment of a method for determining relative object positioning.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in any processor-readable or computer-readable storage medium, which can be realized in a non-transitory and tangible form. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

The subject matter presented here relates to improved techniques for accurately determining the relative positioning of objects that are nearby a host system. The exemplary embodiments described here contemplate an object-based system wherein a host object determines the relative positioning of other neighboring objects. Although this description focuses on a vehicular implementation, the techniques and technologies presented here need not be limited to such an implementation. In this regard, other objects, systems, or devices that participate in a dynamic “traffic” environment can utilize the methodologies described here. For example, a suitably configured and equipped bicycle, motorcycle, pedestrian-worn device, aircraft, watercraft, skateboard, or scooter can take the place of a vehicle in the exemplary embodiment described below. A system that includes vehicles is illustrated and described here for the sake of convenience, and is not intended to limit or otherwise restrict the application or use of the relative positioning methodology.

In one example, a wireless communication module (such as a Wi-Fi access point or a DSRC onboard device) onboard the host object wirelessly communicates with compatible wireless communication modules onboard the neighboring objects to obtain information that can be used to calculate object-to-object position information (e.g., range information and/or bearing angle information). The host object also includes one or more range sensor systems that detect the distance between the host object and the neighboring objects. A range sensor system onboard the host object may be, for example, a camera-based system, an ultrasonic detector system, or the like. A suitably configured control module or processing system onboard the host object utilizes a data fusion algorithm to determine the relative positioning of the neighboring objects based on the information obtained from the wireless object-to-object communication and the information obtained from the range sensor system.

Although the system onboard the host object can leverage traditional GPS-based methodologies for purposes of determining relative object positioning, the approach presented here need not rely on a GPS system. Accordingly, the fusion-based techniques and methodologies described in more detail below can still be used with confidence during periods of GPS outage or when GPS data may be unreliable. For the sake of brevity, conventional techniques related to vehicle operating systems, vehicle sensor systems, vehicle communication systems, and vehicle-to-vehicle positioning systems, including those based on GPS technology, may not be described in detail herein.

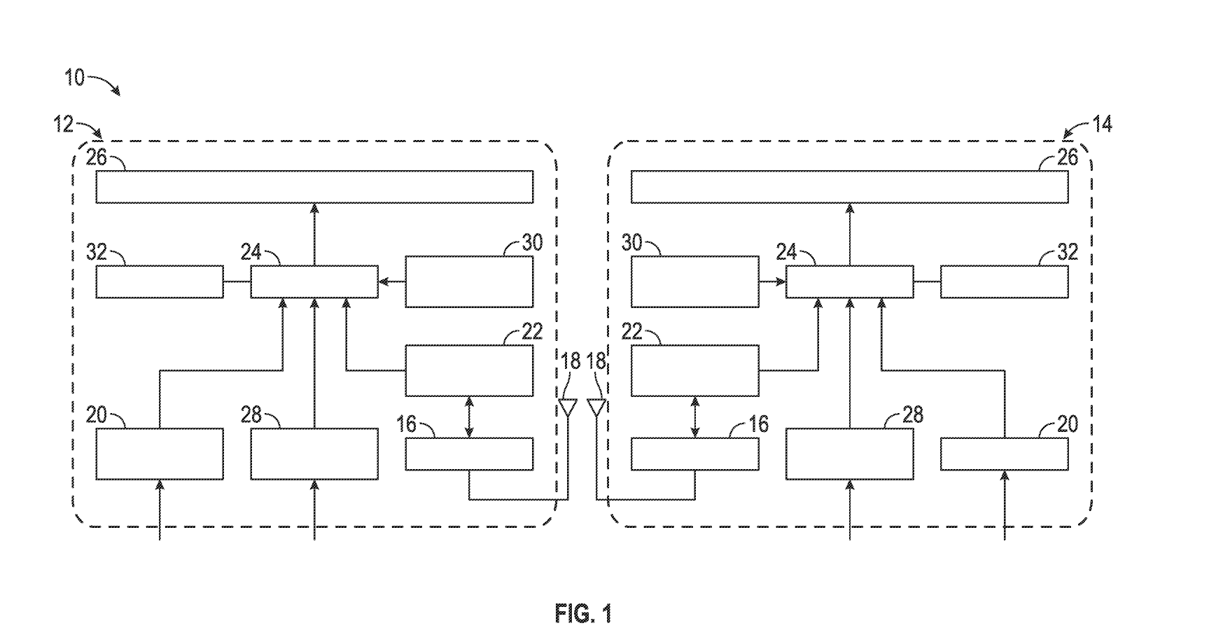

Referring now to the drawings, FIG. 1 is a block diagram that illustrates a system 10 having system components onboard a host object 12 and a neighboring object 14. Although the following description refers to automobiles, the concepts presented here can be deployed in other object types, such as aircraft, spacecraft, watercraft, motorcycles, and the like. Moreover, the concepts presented here may also be deployed in non-vehicular applications if so desired. The host object 12 and the neighboring object 14 are each equipped with a suitably configured system for determining the relative position between the objects. The following description refers to the “host object” in the context of the particular object that obtains the information necessary to calculate the relative positioning of neighboring objects. In this regard, the host object 12 can determine the position of the neighboring object 14 (and other neighboring objects, which are not depicted in FIG. 1) relative to the current position of the host object 12, which may be considered to be the reference position or an absolute position for the V2V calculations.

The systems onboard the host object 12 and the neighboring object 14 each include, without limitation: a wireless communication module 16; an antenna 18; a GPS receiver 20; a data compression and decompression unit 22; a processing architecture having at least one processor device 24; one or more safety applications 26; an interface device 28; and a range sensor system 30. These items are onboard their respective objects 12, 14. In certain embodiments, the items shown in FIG. 1 are integrated within the respective objects 12, 14 in that they may be considered to be native components, features, or modules of the objects 12, 14. In other embodiments, one or more of the items depicted in FIG. 1 can be integrated within a mobile electronic device that is located onboard the host object. For example, the GPS receiver 20 and/or the wireless communication module 16 can be realized in a user's smartphone device, in a user's portable navigation device, in a user's tablet or laptop computer, or the like.

The wireless communication module 16 includes a transmitter and a receiver (or transceiver) for broadcasting and receiving wireless data packets through the antenna 18. Thus, the wireless communication module 16 onboard the host object 12 can wirelessly communicate packets with the wireless communication module 16 onboard the neighboring object 14, and vice versa. The communicated packets can be data packets, lightweight beacon packets, or the like. In certain embodiments, the wireless communication module 16 is implemented as a Wi-Fi access point that is compatible with the IEEE 802.11 standard. Other wireless technology as possible alternatives include, but are not limited to: Dedicate Short Range Communication (DSRC); Bluetooth; Bluetooth low energy (BLE) that operate on unlicensed frequency bands; or other futuristic short- and medium-range communication technology such as cellular Device-to-Device (D2D) communication. It should be appreciated that the wireless communication module 16 can support other wireless communication protocols or standards, as appropriate to the particular embodiment.

The GPS receiver 20 is suitably configured to obtain GPS data, which in turn can be processed in a conventional manner to indicate the current geographical position of the respective object 12, 14. The GPS receiver 20 receives satellite ephemeris, code range, carrier phase and Doppler frequency shift observations. The received information can be processed by the object to resolve the current GPS position of that particular object.

The data compression and decompression unit 22 is utilized to reduce for reducing the communication bandwidth requirement. Each object also includes at least one processor device 24 for constructing a (V2V) object map. The constructed V2V object map is used by the safety applications 26. Each object may also include an interface device 28 for collecting object kinematic data from sensors (not shown) onboard the object. This type of sensor data may include, without limitation: object/wheel speed data; yaw rate data; steering angle data; accelerometer data; pitch data; and the like.

In an exemplary vehicle application, the processor device 24 (and possibly other items shown in FIG. 1) can be implemented in an onboard electronic control unit (ECU) of the vehicle. Although one ECU can manage the described functionality, various embodiments may employ a plurality of ECUs to support the functionality in a cooperative and distributed manner. The processor device 24 is capable of executing computer readable instructions stored in a storage medium 32, wherein the instructions cause the processor device 24 to perform the various processes, operations, and functions described herein. In practice, the processor device 24 may be implemented as a microprocessor, a number of discrete processor devices, content addressable memory, an application specific integrated circuit, a field programmable gate array, any suitable programmable logic device, discrete gate or transistor logic, discrete hardware components, or any combination designed to perform the functions described here.

The range sensor system 30 is suitably configured to obtain range information related to the range of neighboring objects relative to the host object 12. The range sensor system 30 includes one or more sensors or detectors that can detect the presence of neighboring objects. The range sensor system 30 may include any of the following (individually, or in any desired combination): a camera-based or image-based system; a lidar system; an ultrasonic sensor system; an infrared sensor system; a radar system; an electromagnetic sensor system; etc. The specific way in which the range sensor system 30 detects and determines the range/position of the neighboring object 14 will vary depending on the particular type of range sensor technology. The system described here can leverage known range sensor or detector technology, which will not be described in detail here.

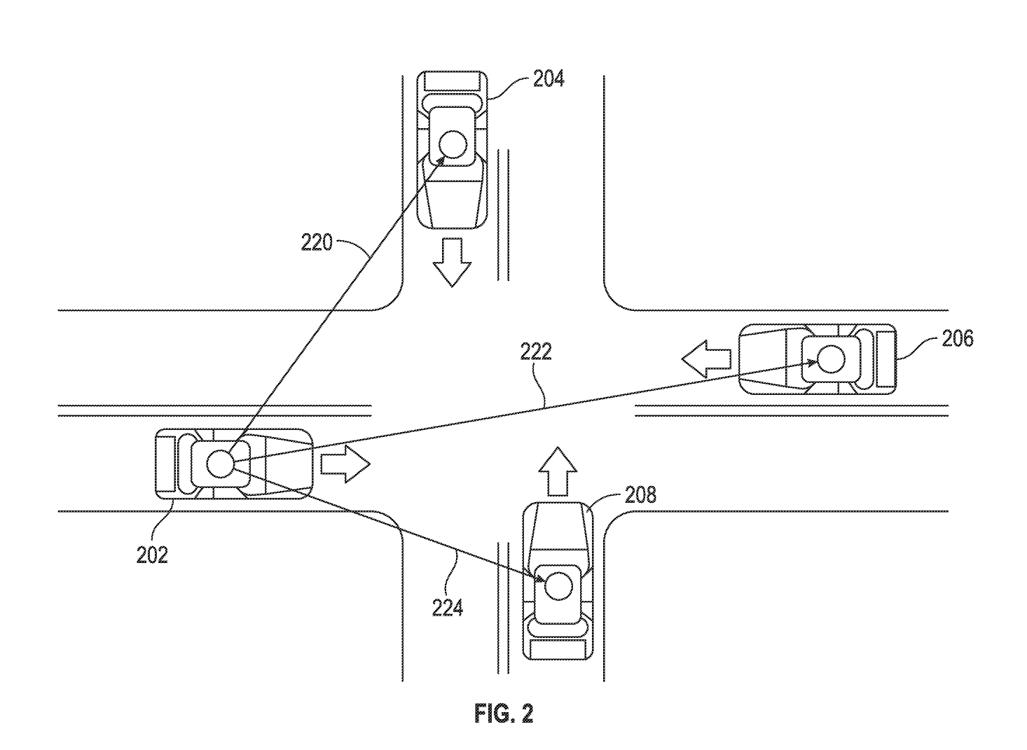

FIG. 2 is a top view diagram that illustrates a host vehicle 202 and three neighboring vehicles 204, 206, 208 approaching a road intersection. The arrows in front of each vehicle represents the direction of travel. The technology described here allows the host vehicle 202 to accurately and precisely determine the relative positioning of the neighboring vehicles 204, 206, 208 without relying on GPS data. In FIG. 2, the arrow 220 represents a measurement ρ₁ (e.g., a range or a bearing angle) that indicates the position of the neighboring vehicle 204, wherein the measurement is acquired by the host vehicle 202. In this context, the measurement can be acquired from the range sensor system onboard the host vehicle and/or by using the wireless communication modules onboard the vehicles 202, 204. Similarly, the arrow 222 represents a measurement ρ₂ that indicates the position of the neighboring vehicle 206, and the arrow 224 represents a measurement ρ₃ that indicates the position of the neighboring vehicle 208, wherein the measurements are acquired by the host vehicle 202.

For the example illustrated in FIG. 2, the locations of the wireless communication modules onboard each of the neighboring vehicles are identified as follows. In this regard, p₁ indicates the position of the wireless communication module onboard the neighboring vehicle 204, p₂ indicates the position of the wireless communication module onboard the neighboring vehicle 206, and p₃ indicates the position of the wireless communication module onboard the neighboring vehicle 208.

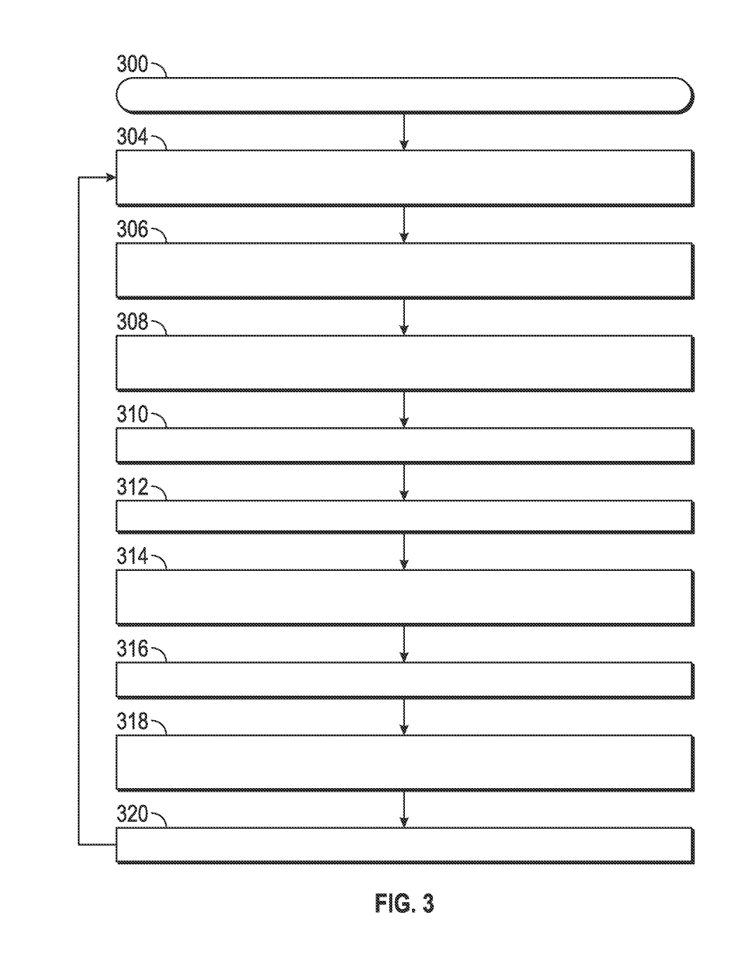

FIG. 3 is a flow chart that illustrates an exemplary embodiment of an object positioning process 300. The process 300 represents one implementation of a method for determining a relative position between a host object and a neighboring object that is in proximity to the host object. The process 300 is shown and described here in the context of only one neighboring object. It should be appreciated that the process 300 can be utilized in an equivalent manner to collect information and data for any number of neighboring objects such that the host object can determine the relative position and velocity of each neighboring object.

The various tasks performed in connection with the process 300 may be performed by software, hardware, firmware, or any combination thereof. For illustrative purposes, the following description of the process 300 may refer to elements mentioned above in connection with FIGS. 1 and 2. In practice, portions of the process 300 may be performed by different elements of the described system, e.g., a wireless module, an onboard range sensor or detector, an ECU, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

From the perspective of the host object, one iteration of the process 300 can be performed at any practical rate. In certain embodiments, the process 300 is performed ten times per second. Of course, the iteration frequency of the process 300 may be lower or higher as appropriate to the particular embodiment. For each iteration of the process 300, one or more systems or modules onboard the host object receives, obtains, or otherwise acquires the data and information that is used to determine the reference position of the host object and the relative positions of the neighboring objects. In this regard, the process 300 operates the wireless communication module onboard the host object to wirelessly communicate data packets with the wireless communication module onboard the neighboring object (task 304). Wireless packets are communicated between the onboard wireless communication modules in a way that enables the host object to determine range and/or bearing angle information for the neighboring object. For example, wireless packets including time stamp data and an identifier (e.g., a MAC address) of the transmitting wireless module can be processed to calculate the time of flight between the two objects, and the calculated time of flight can be used to calculate the distance between the two objects. In certain embodiments, the time of flight is calculated using a lower-layer differential time-of-arrival mechanism. In this way, the host object can process the data packets wirelessly received from the neighboring object to obtain corresponding position information related to the position of the neighboring object relative to the host object.

The process 300 also controls the operation of at least one range sensor system onboard the host object to obtain measurement data (e.g., range information and/or bearing angle information) related to the range, position, bearing, or location of the neighboring object relative to the host object (task 306). In certain embodiments, the range sensor system is operationally independent and distinct from the wireless communication module of the host object. The range sensor system can include an emitter and a receiver that allows the range sensor system to detect the neighboring object. For example, the range sensor system may use an infrared or ultrasonic emitter. In other embodiments, the range sensor system can include a camera or other imaging component that captures images of the neighboring object and processes the image data to determine the relative positioning of the neighboring object.

Although not required, the process 300 can utilize GPS data if available. Thus, the illustrated embodiment of the process 300 operates the GPS receiver onboard the host object to obtain corresponding GPS data that is associated with or otherwise indicates the current geographical position of the host object (task 308). As mentioned above, the GPS receiver functions in a conventional manner to obtain and process information received from GPS satellites, including, without limitation: ephemeris information; satellite clock/time information; code and carrier phase information; and GPS almanac information. The GPS receiver and/or associated processing module onboard the host object processes the received GPS data to determine the geographical position of the host object. The determined geographical position of the host object can also be utilized to compute the relative position between the host object and the neighboring object.

In certain embodiments, the process 300 acquires host object kinematics data from one or more sensors or other sources onboard the host object (task 310). The acquired kinematics data is indicative of the dynamic state or condition of the object. In this regard, the kinematics data of the host object can include wheel speed data, yaw rate data, acceleration data, steering angle data, or the like. The kinematics data of the host object can be utilized to compute the relative position between the host object and the neighboring object.

The host object can also process data and information provided by the neighboring object. In this regard, the process 300 can wirelessly receive supplemental data at the host object (task 312), wherein the supplemental data is transmitted from the neighboring object. In certain embodiments, the wireless communication modules 16 (see FIG. 1) onboard the objects can be utilized to wirelessly communicate the supplemental data from the neighboring object to the host object. Some or all of the received supplemental data can be processed by the host object and utilized as needed to compute the relative position between the host object and the neighboring object. The supplemental data received at task 312 can include any of the information described above with reference to tasks 304, 306, 308, and 310, as obtained by the systems onboard the neighboring object. Accordingly, the supplemental data can include any of the following, without limitation: measurement data derived from wireless packet time of flight analysis; measurement data or information related to the range of the host object relative to the neighboring object, as obtained by a range sensor system onboard the neighboring object; GPS data or geographical position information derived from GPS data received by the GPS receiver onboard the neighboring object; neighboring object kinematics data obtained from one or more sensors onboard the neighboring object; an object list that is indicative of relative positioning of the host object and (if applicable) other neighboring objects, wherein the object list is generated by the neighboring object; the V2V radio signal strength (e.g., RSSI values) of other objects received at the neighboring object as well as its derivative pattern of these signal strength values; and the like. It should be appreciated that the supplemental data received at task 312 may include data obtained by the neighboring object during the current iteration of the process 300 and/or during one or more previous iterations of the process 300.

Although the collection of supplemental data (task 312) need not be performed at all times, this example assumes that the host object does indeed obtain at least some supplemental data from the neighboring object. Accordingly, the process 300 continues by associating an object list that is associated with the obtained measurement data (e.g., the positioning data generated from the onboard range sensor system) with a corresponding object list received from the neighboring object (task 314). In certain embodiments, each neighbor object compiles its object list based on its GPS location information, the relative ranging information received from its own neighboring objects, and other supplementary information. In similar fashion, the host object can accomplish the same task following the same methodology. The object list from the neighbor objects and the host object could be merged and synergetically fused to further correct the information accuracy and fidelity of location information associated with each object in the object list, if an intelligent data fusion algorithm is involved.

Next, the process 300 continues by estimating a reference or absolute position of the host object (task 316), using at least some of the information obtained or generated during the current iteration of the process 300. Task 316 can be based on a local east-north-up (ENU) coordinate frame, relative to the host object. The process 300 also calculates the relative position of the neighboring object, based on the reference position of the host object (task 318). Notably, the relative positioning between the host object and the neighboring object can be computed using the position information obtained from the wireless time-of-flight analysis and the measurement information (e.g., the range information and/or the bearing angle information) obtained from the onboard range sensor system. In addition, task 318 can compute the relative positioning using the GPS data received by the GPS receiver located onboard the host object. Moreover, task 318 can compute the relative positioning using any portion of the supplemental data received from the neighboring object.

After calculating the reference position of the host object and the relative positioning of the neighboring object, the process 300 outputs the relative positioning information (e.g., a V2V object map) to at least one higher level safety application for handling in an appropriate manner (task 320). In this regard, the safety application can generate an alert and/or control one or more subsystems or components of the host object in response to the current V2V status.

The process 300 can leverage various techniques, methodologies, and algorithms to resolve the relative positioning of neighboring objects. Indeed, the various embodiments employ data fusion techniques to determine the relative positioning based on the measurement data obtained from wireless communication between the wireless modules, and further based on the measurement data obtained from the onboard range sensor systems. Although one exemplary methodology is presented below, it should be appreciated that other approaches can be used in an equivalent manner.

In accordance with certain embodiments, estimated positions or position probability distributions are communicated among all compatible objects in the “neighborhood” under analysis. This is the base V2V architecture that may have satellite signal reception issues. GPS measurements can be used to obtain an initial value of object position. Objects equipped with wireless ToF capability or onboard sensors are configured to measure the relative range and bearing angles of their neighbors. GPS data (pseudo-range, carrier phase, and Doppler) measures object relative information with respect to satellites. All of these measurements are fused to refine/correct the position of the objects in a generic and uniform way.

Each object computes its optimal position for itself and its neighbors, given the available information. Two cooperative fusion algorithms are outlined here. The object position will be converged to its true position in several epochs. Thereafter, the refined positions (including neighboring objects) are broadcasted to one or more subsystems or applications for use in an appropriate manner.

The following description uses an information array to represent a Gaussian distribution p˜N(μ, Σ): p˜[R,z], where R^{T} R=Σ⁻¹, Rp=z. This exemplary algorithm, which can be executed by the processor device 24 shown in FIG. 1 can be summarized in accordance with the following sequentially executed tasks:
1. Use the local East-North-Up (ENU) coordinate frame to represent position.
2. Acquire measurements (from onboard range sensors, GPS, or time of flight (ToF) from the wireless modules) ρ₁, μ₂, . . . , ρ_{M}, where each measurement can be a range or a bearing angle.
3. Acquire wireless broadcasting packets from neighboring objects and cache them into the storage medium 32;
4. Use the MAC addresses corresponding to the wireless ToF measurements to query the best estimated position of the remote wireless modules from the neighboring object data packets, i.e., p₁, p₂, . . . , p_{M}. These positions are either received from remote neighboring objects or derived from information stored in the storage medium 32 of the reference host object.
5. For GPS measurements, derive the position of the associated satellites.
6. Associate the object list from onboard sensors with the position list of neighboring objects and the object list received from neighboring objects.
7. Estimate the host object reference position using the algorithm described below.
8. Update the object list given the new host object reference position. Deliver the object list to the destination onboard object system, e.g., the object safety application.
9. Generate new data packet broadcast via the wireless communication module 16.

For purposes of illustration, consider two measurements: ρ₁ (range) and ρ₂ (bearing); where σ₁ and σ₂ are the corresponding standard deviation for the two measurements. Let pⱼ=(Xⱼ, Yⱼ, Zⱼ)^{T} be the positions of the two objects or satellites, where two measurements are acquired from, for j=1, 2. For this expression, X, Y, and Z represent the position displacement along east, north, and up axes of the local coordinate frame, respectively, and T is a matrix transpose operator. Thus, X, Y, and Z at a given time corresponds to the three-dimensional location of the object.

Let \tilde{ρ}₁=\sqrt{(\tilde{X}−X_{z})²+(\tilde{Y}−Y₁)²+(\tilde{Z}−Z₁)²} and

$${\tilde{ρ}}_{2} = acrtan ( \frac{\tilde{Y} - {Y}_{2}}{\tilde{X} - {X}_{2}} )$$

be predicted measurements for pi and ρ₁ and ρ₂, respectively, given \tilde{p}=(\tilde{X}, \tilde{Y}, \tilde{Z})^{T} denoting the object position of the previous estimation. Initially, \tilde{p} is set to the object position estimated by an appropriate positioning technique (e.g., GPS, cellular, and Wi-Fi networks). Let r²=(\tilde{X}−X₂)²+(\tilde{Y}−Y₂)²,

$$H = ( \begin{matrix}\frac{\tilde{X} - {X}_{1}}{{\tilde{ρ}}_{1} {σ}_{1}} & \frac{\tilde{Y} - {Y}_{1}}{{\tilde{ρ}}_{1} {σ}_{1}} & \frac{\tilde{Z} - {Z}_{1}}{{\tilde{ρ}}_{1} {σ}_{1}} \\ - \frac{\tilde{Y} - {Y}_{2}}{{r}^{2} {σ}_{2}} & \frac{\tilde{X} - {X}_{2}}{{r}^{2} {σ}_{2}} & 0\end{matrix} ) , Δρ = ( \begin{matrix}{ρ}_{1} \\ {ρ}_{2}\end{matrix} ) - ( \begin{matrix}{\tilde{ρ}}_{1} \\ {\tilde{ρ}}_{2}\end{matrix} ) .$$

In matrix form: H(p−\tilde{p})=Δρ, or Hp=o, where o=H\tilde{p}+Δρ.

In the above expression, r represents the range in the X-Y plane, and H is a transformation matrix that translates the object position into measurements. In realistic scenarios, it shall be understood that the number of rows in matrix H need not be limited to only two. Rather, the number of rows will equal the number of measurements acquired by the host object.

If GPS data is available, then additional measurements (e.g., pseudo range, carrier phase, and Doppler) for the host object can be appended as extra rows in matrices H and o to the linear system, expressed as Hp=o.

Various least-squares algorithms can be employed to compute the optimized object position p given the above linear system. For numeric robustness, the preferred embodiments employ QR matrix decomposition.

Construct the augmented matrix A=[H o] and apply QR matrix decomposition to it. The result is the upper triangular matrix represented in 2×2 block matrices as

$$[ \begin{matrix}{R}_{0} & {z}_{0} \\ 0 & e\end{matrix} ] ,$$

where R₀ is a 3×3 matrix, z₀ is a 3×1 vector, and the scalar e is the residue. The correct initial host object position is p̅₀=(R₀)⁻¹z₀. The distribution of host object position is p₀˜[R₀, z₀]. Let \tilde{p}=p̅₀; and loop the least-squares for at most L iterations (five) or until convergence is reached. In this regard, the algorithm used here is iterative—an initial position is estimated/determined, and then the position is refined with each iteration of the algorithm. Thereafter, output the refined host object position p̅₀, and the relative position of the neighboring objects in the host object coordinate frame as an enhanced object list. The object list is broadcasted via wireless channels, and the processor device 24 waits for a new measurement from onboard sensors or a new wireless packet for staring the next epoch of position determination.

Position Tracking Algorithm

The position tracking algorithm is appropriate for high-end processors. The tracking algorithm monitors the stored historical positions of neighboring objects, along with the object onboard dynamic sensors, and computes the current position distributions. Each object broadcasts the position probability distributions of itself and its compiled list of neighboring objects.

The system described here can be utilized to determine the current relative positioning of neighboring objects in the host object coordinate frame, and to track the positions in an ongoing manner (until the objects become out of range of the host object). Although any suitable tracking algorithm can be utilized in this context, the following exemplary embodiment is presented as one appropriate methodology. For this example, the input includes the measurement data from the wireless ToF module and onboard sensors, i.e., ρ₁, ρ₂, . . . , ρ_{M}. The input also includes the corresponding neighboring object position distribution in the information array p₁˜[R₁, z₁], p₂˜[R₂, z₂], . . . , p_{M}˜[R_{M}, z_{M}] that are cached in the storage medium 32 in the host object. The input also includes the prior distribution p˜[\tilde{R}, \tilde{z}] based on the previous estimation and object data (e.g., object speed, yaw rate). Thus, the predicted host object position \tilde{p}=\tilde{R}⁻¹\tilde{z}, where \tilde{p}≡(\tilde{X}, \tilde{Y}, \tilde{Z})^{T}. The output includes: the posterior distribution for the host object position p˜[\hat{R}, \hat{z}]; the updated host object position (the mean of the distribution) \hat{p}=\hat{R}⁻¹\hat{z}, the new prior distribution p˜[\tilde{R}, \tilde{z}]; and the relative neighboring object positions in the host object coordinate frame. For ease of description, the tracking methodology is described in the context of certain processing tasks. As described above for the least-squares algorithm, the tracking algorithm uses the world ENU coordinate frame to represent position.

Task 1: Acquire measurements (using onboard range sensors or ToF from wireless modules) ρ₁, ρ₂, . . . , ρ_{M}, where each measurement can be a range or a bearing angle.

Task 2: Acquire wireless broadcasting packets from neighboring objects and cache them into the storage medium 32. The cached data includes the neighboring object position distributions represented in the information array p₁˜[R₁, z₁], p₂˜[R₂, z₂], . . . , p_{M}˜[R_{M}, z_{M}], for objects 1, 2, . . . , M, respectively.

Task 3: If this is the initial task for the current host object, compute the distribution of the initial host object position p˜[\tilde{R}, \tilde{z}] based on GPS data.

Task 4: Use the MAC addresses associated with the wireless ToF measurements to query the best estimated position of the remote wireless modules, i.e., p₁, p₂, . . . , p_{M}. These positions are the mean of the distribution of neighboring objects cached in the storage medium 32.

Task 5: For GPS measurements, derive the position of the associated satellites.

Task 6: Associate the object list from onboard sensors with both the position list of neighboring objects and the object list received from neighboring objects.

Task 7: Compute linearized measurement equation in terms of the host and neighboring object positions. For example, assume that ρⱼ is a wireless ToF, compute the quantities \tilde{ρ}ⱼ=\sqrt{(\tilde{X}−Xⱼ)²+(\tilde{Y}−Yⱼ)²+(\tilde{Z}−Zⱼ)²}; pⱼ=(Xⱼ, Yⱼ, Zⱼ)^{T}; Δρⱼ=ρⱼ−\tilde{ρ}ⱼ; 1×3 matrices H_{v,j}=\tilde{p}^{T}/(σⱼ\tilde{ρ}ⱼ), Hⱼ=−(1 1 1)/(σⱼ\tilde{ρ}ⱼ); oⱼ=(Δρⱼ+H_{v,j}\tilde{p})/σⱼ; for j=1, 2, . . . , M. Construct the matrix A:

$$A = ( \begin{matrix}{R}_{1} & 0 & … & 0 & 0 & {z}_{1} \\ 0 & {R}_{2} & … & 0 & 0 & {z}_{2} \\ ⋮ & ⋮ & ⋱ & ⋮ & ⋮ & ⋮ \\ 0 & 0 & … & {R}_{M} & 0 & {z}_{M} \\ 0 & 0 & … & 0 & \tilde{R} & \tilde{z} \\ {H}_{1} & 0 & … & 0 & {H}_{v , 1} & {o}_{1} \\ 0 & {H}_{2} & … & 0 & {H}_{v , 2} & {o}_{2} \\ ⋮ & ⋮ & ⋱ & ⋮ & ⋮ & ⋮ \\ 0 & 0 & … & {H}_{M} & {H}_{v , M} & {o}_{m}\end{matrix} )$$

Task 8: Apply Givens rotation to the entries that appear in the lower four rows of matrix A, to triangulate the matrix A. Since the matrix is sparse, the operation is applied to matched row pairs <Rᵢ, Hᵢ> for the row i=M, M-1, . . . , 1. This results in the following upper triangular matrix:

$${R}_{A =} ( \begin{matrix}{R}_{1}^{′} & 0 & … & 0 & {α}_{1} & {z}_{1}^{′} \\ 0 & {R}_{2}^{′} & … & 0 & {α}_{2} & {z}_{2}^{′} \\ ⋮ & ⋮ & ⋱ & ⋮ & ⋮ & ⋮ \\ 0 & 0 & … & {R}_{M}^{′} & {α}_{M} & {z}_{M}^{′} \\ 0 & 0 & … & 0 & \hat{R} & \hat{z} \\ 0 & 0 & … & 0 & 0 & e \\ ⋮ & ⋮ & ⋱ & ⋮ & ⋮ & ⋮ \\ 0 & 0 & … & 0 & 0 & 0\end{matrix} )$$

The posterior distribution of the host object position p˜[\hat{R}, \hat{z}] where \hat{R} is the 3×3 submatrix in R_{A} and \hat{z} is the 3×1 submatrix in R_{A}, the position expectation (mean) is \hat{p}=\hat{R}⁻¹\hat{z}.

Task 9: Compute the j-th neighboring object's distribution pⱼ˜[R′ⱼ, z′ⱼ−αⱼ\hat{p}], for j=1, . . . , M. Calculate the mean of the neighboring objects.

Task 10: Given the position \hat{p} at time t, with distribution p=[\hat{R}, \hat{z}], the predicted position at t+Δt is modeled as \tilde{p}=ƒ(\hat{p}, v)+w, v is the velocity vector (including speed, yaw rate), and w is the Gaussian noise vector with zero-mean and unity covariance. Linearize the above nonlinear dynamic equation into a neighborhood of \hat{p}: F\tilde{p}+G\hat{p}=u+w, with F and G the Jacobians to \tilde{p} and \hat{p}, respectively, and u the term irrelevant to \tilde{p} and \hat{p}. Constructing the matrix

$$( \begin{matrix}\hat{R} & 0 & \hat{z} \\ G & F & u\end{matrix} ) ,$$

and applying QR
decomposition, obtain the upper triangular matrix

$$( \begin{matrix}α & β & γ \\ 0 & \tilde{R} & \tilde{z}\end{matrix} ) .$$

The predicted position is \tilde{p}=\tilde{R}⁻¹\tilde{z}, distributed as p˜[\tilde{R}, \tilde{z}], and is ready for arrival of new measurements.

Task 11: Given the neighboring object's positions \hat{p}ⱼ for j=1, . . . , M for host object position \hat{p}, compute the relative position of the neighboring object in the host object frame as an enhanced object list. Deliver the list to the destination onboard object system, e.g., the safety application.

Task 12: Generate new data packet containing the probability distribution of the host and neighboring objects, and broadcast it via the wireless module 16 to one or more onboard systems for handling.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method for determining a relative position between a host object and a neighboring object in proximity to the host object, the method comprising:
operating a first wireless communication module onboard the host object to wirelessly communicate packets with a second wireless communication module onboard the neighboring object;
processing, by a processor device onboard the host object, packets wirelessly received from the second wireless communication module to calculate a time of flight that indicates distance between the neighboring object and the host object;
operating a range sensor system onboard the host object to obtain first range information related to a range of the neighboring object relative to the host object;
calculating, by the processor device onboard the host object, a reference position of the host object; and
computing, by the processor device onboard the host object, the relative position between the host object and the neighboring object using the calculated reference position of the host object, the calculated time of flight, and the obtained first range information.

2. The method of claim 1, wherein the packets wirelessly communicated comprise data packets or lightweight beacon packets.

3. (canceled)

4. The method of claim 1, wherein the processing step calculates the time of flight using a lower-layer differential time-of-arrival mechanism.

5. (canceled)

6. The method of claim 1, further comprising:
acquiring host object kinematics data from sensors onboard the host object, wherein the computing step computes the relative position between the host object and the neighboring object using the calculated reference position of the host object, the calculated time of flight, the obtained first range information, and the obtained host object kinematics data.

7-13. (canceled)

14. A system for determining a relative position between a host object and a neighboring object in proximity to the host object, the system comprising:
a first wireless communication module onboard the host object to wirelessly communicate data packets with a second wireless communication module onboard the neighboring object;
a range sensor system onboard the host object to obtain first range information related to a range of the neighboring object relative to the host object; and
a processor device to process data packets wirelessly received from the second wireless communication module to calculate a time of flight that indicates distance between the neighboring object and the host object, to calculate a reference position of the host object, and to compute the relative position between the host object and the neighboring object using the calculated reference position of the host object, the calculated time of flight, and the obtained first range information.

15. (canceled)

16. The system of claim 14, further comprising:
a source of host object kinematics data onboard the host object, wherein the processor device computes the relative position between the host object and the neighboring object using the calculated reference position of the host object, the calculated time of flight, the obtained first range information, and the host object kinematics data.

17. The system of claim 14, wherein the first wireless communication module is integrated within the host object.

18. The system of claim 14, wherein the first wireless communication module is integrated within a mobile electronic device located onboard the host object.

19. A tangible and non-transitory computer readable storage medium having executable instructions stored thereon that, when executed by a processor device onboard a host object, are capable of performing a method comprising:
wirelessly communicating data packets between a first wireless communication module onboard the host object and a second wireless communication module onboard a neighboring object;
processing data packets wirelessly received from the second wireless communication module to calculate a time of flight that indicates distance between the neighboring object and the host object;
operating a range sensor system onboard the host object to obtain first range information related to a range of the neighboring object relative to the host object;
calculating a reference position of the host object and
computing the relative position between the host object and the neighboring object using the calculated reference position of the host object, the calculated time of flight, and the obtained first range information.

20. (canceled)
